(19) United States
(12) Patent Application Publication
(10) Pub. No.: US 2005/0145354 A1
(43) Pub. Date: Jul. 7, 2005

(54) Glitter paper product

(76) Inventors: Stephen J. Swanson, Appleton, WI (US); Jason D. Henke, Neenah, WI (US)

Correspondence Address: LADAS & PARRY LLP, 224 SOUTH MICHIGAN AVENUE, SUITE 1200, CHICAGO, IL, 60604, US

(21) Appl. No.: 10/748,353

(22) Filed: Dec. 30, 2003

(51) Int. Cl. B32B 5/16; B32B 29/00; D21H 17/63

(52) U.S. Cl. 162/181.1; 428/328; 428/533; 428/537.1; 162/135

(57) ABSTRACT

A paper product having shiny “glitter” particles dispersed in a random but essentially uniform fashion over the surface of the paper and a process for making the paper product in which metallic particles are mixed with a pulp slurry in the fourdrinier paper making process in an amount from 2-4% by weight.

### BACKGROUND OF THE INVENTION

The present invention relates to a new paper product and to a process for making same. More particularly, the present invention relates to a paper sheet containing glitter particles. The paper product of this invention has shiny “glitter” particles dispersed in a random but essentially uniform fashion over the surface of the paper to provide a surface in which the glitter particles reflect light and are visible over a wide viewing angle with respect to the plane of the paper. The paper of this invention has many uses, but perhaps the most common use would be as a “construction paper” for use by children in creating cut-outs or other objects.

Children's “construction paper” comes in many weights and colors. In the past children have applied a glue in a decorative pattern to such paper and have then applied minute metallic glitter particles to the glue. When the glue dries the glitter particles adhere to the glue creating a decorative sparkle pattern where the glue was applied. A similar approach has been used in the greeting card industry and elsewhere.

The problem with such procedures is that some of the glitter particles do not adhere to the glue and fall off and clean-up becomes difficult because of the minute size of the particles. Further glitter particles which might initially adhere to the glue may subsequently fall off.

### SUMMARY OF THE INVENTION

The object of the present invention is to provide a paper in which the glitter particles are embedded and held in the finished paper product, such that they will not readily separate from the paper.

The paper may be cut to a desired decorative shape and applied to a background paper or the sparkle paper might itself be the background for applying plain paper in desired decorative shapes. While the foregoing applications might be a typical use for the paper of this invention, it will be apparent that the paper of this invention could have many other uses.

### DETAILED DESCRIPTION OF THE PREFERRED EMBODIMENTS

The paper of this invention may be made in a typical fourdrinier papermaking machine. Such a machine typically includes a fourdrinier fabric which moves over rollers and upon which a pulp mix, including paper pulp, water, additives, etc. are deposited. Some of the water in the pulp mix is removed on the fourdrinier fabric by gravity, the pulp mix then passes through a wet press section in which water is further removed and the paper web is formed. Then the formed paper web passes through a steam heat section in which the paper web is further dried. After initial drying the paper web may be treated with an ethylated starch solution at a size press and then further dried to a 4-6% moisture content.

Typically, the pulp mix is deposited on the fourdrinier fabric from a pulper tank. The pulper tank receives paper stock and water and includes means to comminuate the paper stock and agitate the material in the tank so as to form a slurry which constitutes the pulp mix.

In a preferred embodiment the slurry includes 4-12% by weight paper fibers more preferably 5-7%. The slurry consists of varying amounts of ground wood, sulfate, kraft fibers or other paper products. After 5 to 10 minutes of agitation the slurry is broken down into individual fibers. A paper dye may be added to the slurry to achieve the desired paper color. In accordance with this invention 2-4% by weight metallic particles are then added to the slurry and agitation continues for 30-45 minutes after the metallic particles are added and the metallic particles are thoroughly mixed in the slurry. Typically 150 lbs. of metallic particles will be added to approximately 6000 lbs. of pulp slurry.

The metallic particles are preferably aluminum foil particles having a silver color although other colors may be used. The metallic particles preferably have an average particle size of 0.002 inches by 0.002 inches (50 microns) and an average thickness of 0.0007 inches (18 microns). One source of the metallic particles used in this invention is Meadowbrook Inventions, Inc. of Bernardsville, N.J. In the preferred process of the invention their metallic particle product IP Brilliant Chrome Silver which conforms to ASTM D4236 has been used.

The metallic particles are preferably added to the slurry in a paper bag which prevents dispersion of the particles into the air at the pulper tank. The paper bag is shredded by the agitator in the pulper tank and the metallic particles are dispersed throughout the pulp mix.

If the paper product is to be colored, dye will be added in the pulper tank in an amount from about 50 lbs. to about 750 lbs. for 6000 lbs. of pulp slurry.

In forming the paper product of this invention on a fourdrinier papermaking machine the fiber/glitter slurry is distributed uniformly over a forming fabric. Water is removed by gravity and vacuum, and the wet, glitter containing, web then undergoes conventional wet pressing and steam heat drying to remove water. The dried sheet is treated with ethylated starch at the size press, and dried again to reduce the moisture content to 4-6%. The glitter is fixed to the sheet by fiber entrapment, wet pressing, and further sealed by an ethylated starch solution applied to both sides of the paper web at the size press. The wet press section acts to press the metallic particles into the paper stock so as to embed them in the paper stock. The ethylated starch solution coats the surfaces of the paper web and prevents any possible dislodgment of the metallic particles.

1. A paper product including a paper sheet having metallic particles dispersed over at least one surface of the paper sheet in a uniform but random fashion, the metallic particles being essentially bound in the paper sheet.

2. A paper product according to claim 1 wherein the metallic particles comprises an aluminum foil.

3. A paper product according to claim 1 in which the metallic particles have an average particle size of 0.002 inches by 0.002 inches (50 microns) and an average thickness of 0.0007 inches (18 microns).

4. A paper product according to claim 1 in which the metallic particles have a silver color.

5. A paper product according to claim 1 in which the paper sheet and metallic particles are coated with an ethylated starch.

6. A paper product according to claim 1 in which the metallic particles are embedded in the paper sheet and are not readily removable.

7. A paper product according to claim 1 in which the paper is colored.

8. A paper product according to claim 1 in which metallic particles are embedded in both surfaces of the paper sheet.

9. A process of making a paper sheet having metallic particles, comprising the steps of:
preparing a paper pulp mix;
adding metallic particles to the pulp mix;
depositing the pulp mix on a fourdrinier fabric of a fourdrinier papermaking machine to form a web;
wet pressing and sizing said web; and
drying said web to form said paper sheet.

10. A process according to claim 9, wherein said metallic particles comprise 2-4% by weight of the pulp mix.

11. A process according to claim 9, in which the metallic particles are added to the pulp mix in a pulper tank and are dispersed throughout the pulp mix by agitation.

12. A process according to claim 10, wherein the metallic particles are subjected to agitation in the pulp mix for 30 to 45 minutes.

13. A process according to claim 11 wherein the metallic particles are contained within a paper bag when added to the pulp mix in the pulper tank.

14. A process according to claim 9, in which an ethylated starch solution is applied to the paper sheet.
